(19) United States
(12) Patent Application Publication
(10) Pub. No.: US 2026/0134378 A1
(43) Pub. Date: May 14, 2026

(54) SYSTEMS AND METHODS FOR MODELING PROCESS-LEVEL INTERACTIONS

(71) Applicant: SAP SE, Walldorf (DE)

(72) Inventors: Majid Rafiei, Aachen (DE); Timotheus Kampik, Umeå (DE); Gregor Berg, Berlin (DE)

(21) Appl. No.: 18/944,997

(22) Filed: Nov. 12, 2024

(51) Int. Cl. G06Q 10/067; G06Q 10/0631; G06Q 10/0633

(52) U.S. Cl. CPC G06Q 10/067; G06Q 10/063114; G06Q 10/0633

(57) ABSTRACT

Some embodiments provide a non-transitory machine-readable medium that stores a program to generate an execution graph. The execution graph includes a semantic layer that is generated based on the processes involved in the system and the object types shared between the processes. The execution graph further includes an execution layer that is generated by modifying the semantic layer to include object instances that are involved in the processes. The execution layer can be presented on a display, thus allowing a user to visualize the process interactions taking place between the processes.

### BACKGROUND

Object-centric process mining (OCPM) is a technique used in data analytics to analyze object-centric event data to discover multi-dimensional end-to-end processes. These discovered processes allow an end user to better understand a process from the perspective of different object types involved in the execution of the process. For example, in the context of a company selling products to the consumer, OCPM may help identify an order management process, a delivery process, or a shipment process. Once the processes are discovered, further analytics may be performed to better understand each process, potentially improving the efficiency or identifying bottlenecks in the process.

While OCPM is a valuable tool, it does have some shortcomings. For example, OCPM focuses on end-to-end processes rather than process-level interactions. This means that it is not possible for end users to identify sub-processes involved in the bigger end-to-end process and to see how those processes interact with one another. This lack of understating the relationship between processes has shortcomings such as preventing the end user from capturing a holistic view of the business, limiting root cause analysis to individual complex processes rather than the entire system as a whole, and inability to capture how changes to one process may have an impact on other processes. Thus, there is a need for improved techniques to capture and model process-level interactions between different processes.

### SUMMARY

In some embodiments, a non-transitory machine-readable medium stores a program executable by at least one processing unit of a device. The program comprises sets of instructions for receiving a first process that includes a first set of object types involved in the first process, a first set of object instances wherein each object instance from the first set of object instances is associated with an object type from the first set of object types, and a first sequence of events detailing the first process, wherein each object instance is assigned to an event from the first sequence of events, receiving a second process that includes a second set of object types involved in the second process, a second set of object instances wherein each object instance from the second set of object instances is associated with an object type from the second set of object types, and a second sequence of events detailing the second process, wherein each object instance is assigned to an event from the second sequence of events, and wherein the first set of object types and the second set of object types share an object type, generating a semantic layer of a graph that includes a first node that represents the first process, a second node that represents the second process, and an edge between the first node and the second node that represents the object type shared between the first process and the second process, modifying the semantic layer according to the first set of object instances and the second set of object instances to generate an execution layer, and presenting the execution layer on a display.

In some embodiments, modifying the semantic layer includes modifying the size of the first node according to a number of object instances from the first set of object instances that are of an object type from the first set of object types.

In some embodiments, the ratio of the size of the first node to the number of instances from the first set of object instances that are of the object type is the same as the ratio of size of the second node to the number of instances from the second set of object instances that are of the object type node.

In some embodiments, modifying the semantic layer includes modifying the size of the first node according to an average execution time of object instances from the first set of object instances that are of an object type from the first set of object types.

In some embodiments, modifying the semantic layer includes modifying the size of the first node according to an average completion rate of the first set of object instances that are of an object type from the first set of object types.

In some embodiments, modifying the semantic layer includes removing the edge when the first set of object instances and the second set of object instances both do not contain at least one object instance having the shared object type.

In some embodiments, modifying the semantic layer includes adjusting the thickness of the edge based on the number of object instances that are shared between the first set of object instances and the second set of object instances.

In some embodiments, modifying the semantic layer includes adjusting the direction of the edge based on a flow direction between the first set of object instances and the second set of object instances.

In some embodiments, modifying the semantic layer includes adjusting the thickness of the edge based on an average flow time between the first set of object instances and the second set of object instances.

In some embodiments, a method comprises receiving a first process that includes a first set of object types involved in the first process, a first set of object instances wherein each object instance from the first set of object instances is associated with an object type from the first set of object types, and a first sequence of events detailing the first process, wherein each object instance is assigned to an event from the first sequence of events, receiving a second process that includes a second set of object types involved in the second process, a second set of object instances wherein each object instance from the second set of object instances is associated with an object type from the second set of object types, and a second sequence of events detailing the second process, wherein each object instance is assigned to an event from the second sequence of events, and wherein the first set of object types and the second set of object types share an object type, generating a semantic layer of a graph that includes a first node that represents the first process, a second node that represents the second process, and an edge between the first node and the second node that represents the object type shared between the first process and the second process, modifying the semantic layer according to the first set of object instances and the second set of object instances to generate an execution layer, and presenting the execution layer on a display.

In some embodiments, a system includes a set of processing units and a non-transitory machine-readable medium that stores instructions. The instructions cause at least one processing unit to receive a first process that includes a first set of object types involved in the first process, a first set of object instances wherein each object instance from the first set of object instances is associated with an object type from the first set of object types, and a first sequence of events detailing the first process, wherein each object instance is assigned to an event from the first sequence of events, receive a second process that includes a second set of object types involved in the second process, a second set of object instances wherein each object instance from the second set of object instances is associated with an object type from the second set of object types, and a second sequence of events detailing the second process, wherein each object instance is assigned to an event from the second sequence of events, and wherein the first set of object types and the second set of object types share an object type, generate a semantic layer of a graph that includes a first node that represents the first process, a second node that represents the second process, and an edge between the first node and the second node that represents the object type shared between the first process and the second process, modify the semantic layer according to the first set of object instances and the second set of object instances to generate an execution layer, and present the execution layer on a display.

The following detailed description and accompanying drawings provide a better understanding of the nature and advantages of various embodiments of the present disclosure.

### BRIEF DESCRIPTION OF THE DRAWINGS

FIG. 1 illustrates a workflow having multiple processes according to some embodiments.

FIG. 2 illustrates a three-level structure for two processes according to some embodiments.

FIG. 3 illustrates a semantic layer of a EG model according to some embodiments.

FIG. 4 illustrates an execution layer of a EG model according to some embodiments.

FIG. 5 illustrates a graphical user interface for interacting with an execution layer of EG model according to some embodiments.

FIG. 6 illustrates a workflow for displaying an execution layer of a EG model according to some embodiments.

FIG. 7 illustrates an exemplary computer system 700 for implementing various embodiments described above.

FIG. 8 illustrates an exemplary computing device 800 for implementing various embodiments described above.

FIG. 9 illustrates an exemplary system 900 for implementing various embodiments described above.

### DETAILED DESCRIPTION

In the following description, for purposes of explanation, numerous examples and specific details are set forth in order to provide a thorough understanding of the present disclosure. It will be evident, however, to one skilled in the art that various embodiments of the present disclosure as defined by the claims may include some or all of the features in these examples alone or in combination with other features described below, and may further include modifications and equivalents of the features and concepts described herein.

Described herein are techniques for analyzing cross-dependencies in processes. Processes are workflows implemented by a company to support the day to day operations. For example, processes for a company selling physical goods can include an order management process for orders to be placed and payments to be received, a delivery process for packaging and delivering the physical goods to the customer, and a shipment process to track the shipment of the package. Each of these processes may include data and event steps that interact with other processes. In order to analyze these process-level interactions and/or dependencies, a solution is described where an application is capable of generating an execution graph (EG). The EG is a model of potential process-level interactions resulting in a semantic layer that is considered a reference graph. Each node in the reference graph represents a different process and each edge connecting two nodes represents a potential interaction between the two processes that are represented by the two nodes. The potential interactions may be defined by the application as object types that are present in both processes. Once the reference graph has been generated, the semantic layer is expanded to the execution layer with the use of object instance level information. An EG is for example a business execution graph. In some embodiments, the application adds in the customer data for each of the processes to the EG model to create the execution layer. As a result, the execution layer is a sub-graph of the semantic layer, where the connections between processes (i.e., edges) are based on joint object instances flowing from one process to another. In some embodiments, the application may adjust the visual appearance of the node based on customer data belonging to the process that is being represented by the node. Since the edges of the semantic layer are based on joint object instances, the application may remove some edges in the reference graph between two nodes when there are no joint object instances flowing from the processes represented by the nodes. The application may present the execution layer of the EG model on a graphical user interface of a display so that an end user is able to visualize the processes that drive the company or business and learn about how the processes interact with one another. In some embodiments, the application may generate multiple EG models representing different companies and overlay the models on top of one another to graphically illustrate the differences between the companies. For example, one EG model may be represented as highlighting over another EG model as a means of comparing the two.

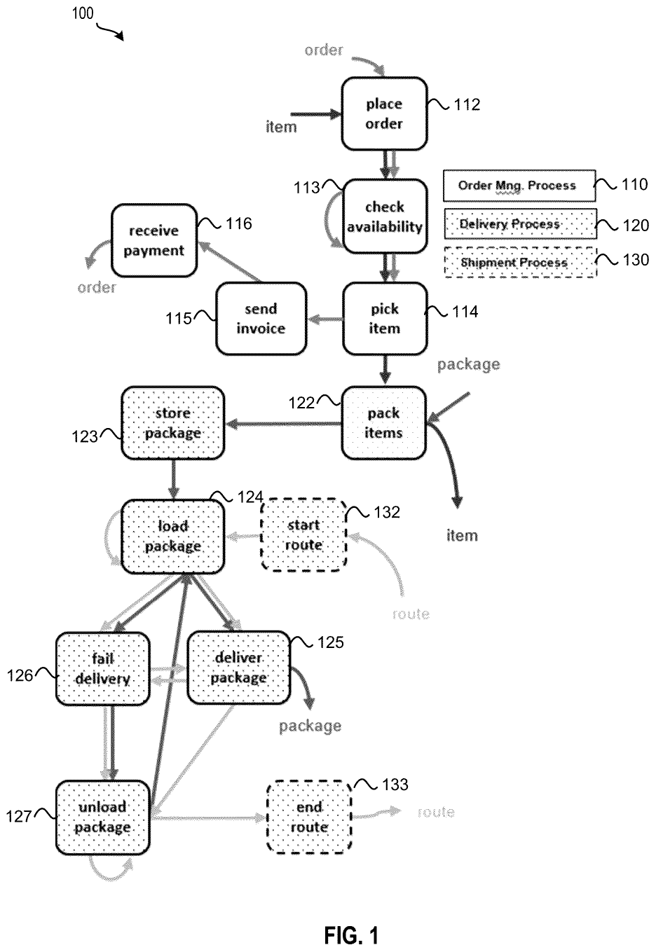

FIG. 1 illustrates a workflow having multiple processes according to some embodiments. The workflow may include the various processes to be executed by one or more entities when processing the sale of a physical item. Each process may include the steps (i.e. events) that are performed when executing said process. The processes may be executed by different entities such as the business owner, the distribution center, and the shipment center. As shown here, workflow 100 illustrates the events that may take place when an entity sells a physical item to a customer. Workflow 100 contains three processes-process 100, process 120 and process 130. In other embodiments, more or fewer processes may exist. Process 110 is an order management process that may be executed by the entity to manage an order placed by a customer. Process 110 starts at event 112 where an order is placed. The order may be for a physical item that is listed for sale by the entity. Once the order has been placed by the customer, process 110 continues to event 113 to check availability of the ordered physical item. Assuming the physical item is available, process 110 continues to event 114 where the physical item is picked up from inventory. Process 110 then continues to event 115 where an invoice is sent for the sale of the physical item to the customer and event 116 where payment is received from the customer for the physical item. Once event 116 is completed, then process 110 is completed.

Workflow 100 further includes process 120. Process 120 is a delivery process that may be executed by a delivery agent. Process 120 starts at event 122 where the item is picked up from the entity and packed. Once the item is packed, process 120 continues to event 123 where the package is stored, waiting delivery. Process 120 then continues to event 124 where the package is loaded onto the delivery vehicle. If the package is successfully delivered to the customer, then process 120 continues to event 125 and process 120 ends. However, if the package is not successfully delivered, then process 120 continues to event 126 which is a failed delivery. If the delivery is unsuccessful, then process 120 continues to event 127 where the package is unloaded from the delivery vehicle, and then subsequently at step 124 can be loaded onto a delivery vehicle (could be the same or different vehicle) for a second attempt at delivery. Process 120 is completed once the delivery has occurred.

Workflow 100 further includes process 130. Process 130 is a shipment process that may be executed by a shipping agent. From a high level, the delivery agent may transfer the package over to the shipping agent. The shipping agent may in turn deliver the package to the customer. However, the delivery agent may track the status of the package while it is being handled by the shipping agent. As a result, some events in process 130 may interact with some events in process 120. For example, event 124 may be a part of process 120 and 130 because the delivery process tracks the status of the package while the shipment process loads the package onto the delivery vehicle. Process 130 starts at event 132 where the delivery vehicle begins its route for the day. At a stop along its route, the package is loaded onto the delivery vehicle at step 124 along with many others. The delivery vehicle stops at the customer's address and attempts delivery. A package may fail delivery if the package requires signature for delivery and nobody is at the residence to sign. If delivery of the package fails, then process 130 continues to event 126 and the package remains on the delivery vehicle. After a long day of trying to deliver packages, process 130 may continue to event 127 where all undelivered packages are unloaded back to where they were previously loaded onto the delivery vehicle. If instead delivery was successful, then process 130 continues to event 125 where the package was delivered. After delivery or unloading the package to where it was previously loaded, process 130 continues to event 133 which is the end of the route.

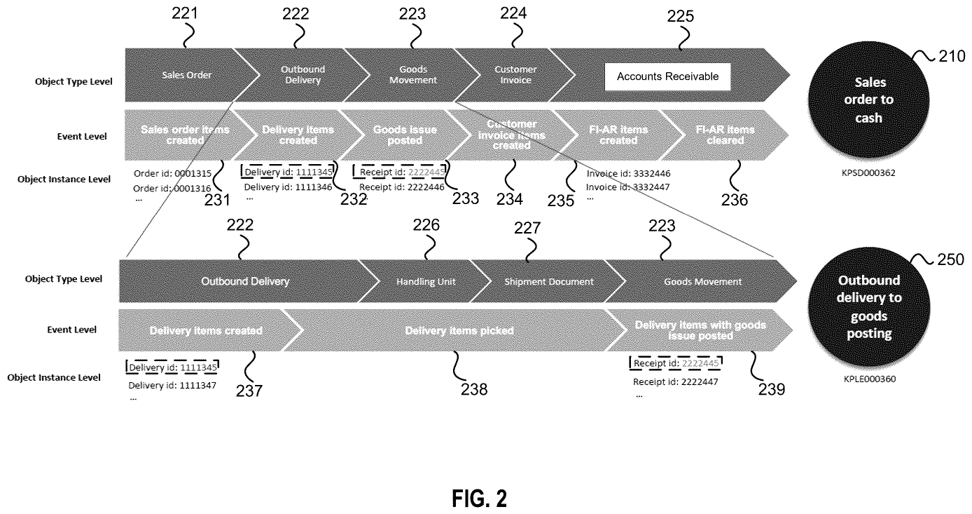

FIG. 2 illustrates a three-level structure for two processes according to some embodiments. The three-level structure shown here may be discovered using tools such as SAP Signavio. The three-level structure includes an object type level, an event level, and an object instance level. The object type level includes object types that are involved in the process. For example, if a process includes a sales order object, then the sales order object would be included as an object type in the object type level. The event level refers to a sequence of events that are the main steps of the process. Similar to a cooking recipe which has steps, the main steps of the process are defined as a sequence of events in the event level. The object instance level refers to the set of object instances that are involved in events of the process. The object instances would be an instantiation of the object type.

As shown here, process 210 and process 250 are two processes that are a part of a group of processes that are used to manage the sale and delivery of a physical item. Process 210 has an event level that includes sequence of events 231-236. Events 231 through 236 may be executed sequentially to perform steps in process 210. Here, process 210 is a process to convert sales to cash, with the following events: “sales order items created” 231, “delivery items created” 232, “goods issue posted” 233, “customer invoice items created” 234, “FI-AR items created” 235, and “FI-AR items cleared” 236. These events involve the following object types from the object type level—221 “Sales Order,” 222 “Outbound Delivery,” 223 “Goods Movement,” 224 “Customer Invoice,” and 225 “Accounts Receivable.” In some embodiments, two events may involve the same object type. For example, events 235 and 236 involve the same object type 225. Process 210 also has an object instance level. The object instance level contains a set of object instances that are involved in the execution of the events in the process. Each object instance is an instantiation of an object type. For example, event 231 includes object instances “Order id: 0001315” and “Order id: 0001316” that are of object type 221 “Sales Order.” Event 232 includes object instances “Delivery id: 1111345” and “Delivery id: 1111346” that are of object type 222 “Outbound Delivery.”

Process 250 also has an event level, an object type level, and an object instance level. As shown, process 250 has some object types in the object type level that are the same as object types in the object type level of process 210. For example, “Outbound Delivery” 222 and “Goods Movement” 223 are object types that are present in both process 210 and process 250. In this example, the EG application may define “Outbound Delivery”222 and “Goods Movement” 223 as joint object types since they represent a potential interaction between processes 210 and 250. Process 250 also include other object types that are not present in process 210, such as “Handling Unit” 226 and “Shipment Document” 227. As shown here, it's possible to have an event involve two object types (e.g., Delivery items picked event 238 involves Handling Unit 226 and Shipment Document 227). Other events in process 250 include delivery items created event 237 and delivery items with goods issue posted event 239. Process 250 also has an object instance level. The object instances are instantiations of object types that are involved in the corresponding process. Some of the object instances may be present in both process 210 and 250. For example, Delivery id: 1111345 and Receipt id: 2222445 (shown in dashed rectangles) are present in both processes 210 and 250. These object instances that are present in both processes are known as joint object instances. The EG application may visualize the joint object instances as edges in the EG model.

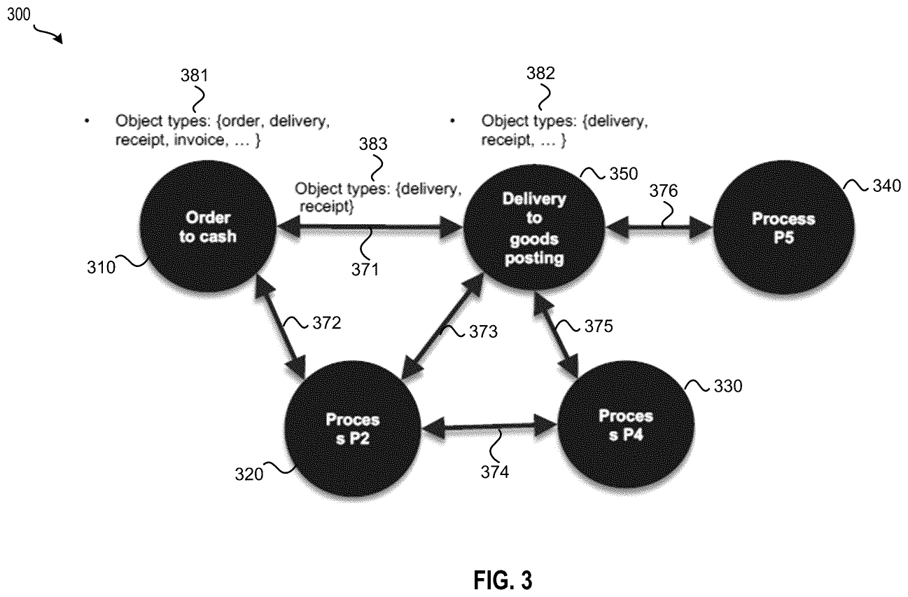

FIG. 3 illustrates a semantic layer of a EG model according to some embodiments. The semantic layer may be generated by a EG application running on a processor. The EG application may receive object type level information on each process and generate semantic layer 300 from the received information. As shown, semantic layer 300 includes nodes 310, 320, 330, 340, and 350. Each node corresponds to a process that is part of an overall system, and the purpose of the semantic layer is to illustrate potential interactions between several processes. For example, order to cash node 310 may correspond to an order to cash process such as process 210 in FIG. 2. Similarly, delivery to goods posting node 350 may correspond to an outbound delivery to goods posting process such as process 250 in FIG. 2. Semantic layer 300 may optionally display the object types that are involved in each process somewhere in close proximity to the node. Here, object types displayed in text 381 are involved in the underlying process that corresponds to node 310 and is being displayed above 310. In other embodiments, the object types may be displayed to the left, to the right, or below the node. As shown here, not all object types are being displayed in text 381. Hovering a cursor over text 381 may display the entire list of object types. In yet other embodiments, the object types may be displayed as a tool tip which are made visible when a one or more conditions are met. A tool tip is a text box that is displayed when one or more conditions are met. Here, the condition is when a cursor hovers over the node. This may be advantageous particularly in a system where there are many processes and therefore room to display object types for each node is limited. Object types displayed in text 382 are involved in the underlying process that corresponds to node 350.

Semantic layer 300 further includes edges that connect the nodes. Each edge corresponds to object types that are interactions between the two processes being represented by the two nodes. These object types that are shared between two processes are also known as joint object types. A potential interaction exists when two processes are involved with the same object type. For example, if the process represented by node 310 and the process represented by node 350 are both involved with the same delivery object type, then edge 371 would exist between the two nodes. A process may be involved with an object type when events within the process potentially analyze data having that object type and they share actual object instances. As shown, edge 371, which connects nodes 310 and 350, represents the joint object types between the underlying processes being represented by nodes 310 and 350. Edge 371 includes arrows pointing towards both nodes because in the semantic layer, it is not yet determined the direction the data flows between the processes. The direction of flow means that joint object instances are being transmitted as output from one process and being received as input in another process. Semantic layer 300 can optionally include text 383 that displays the joint object types shared between the underlying processes of nodes 310 and 350. Similar to text 381 and 382, text 383 may be positioned anywhere near edge 371 to indicate that the information is to supplement edge 371. In some embodiments, text 383 may be a tool tip which is made visible when a curser hovers over edge 371. As shown here, text 383 includes object types deliver and receipt to indicate that these two object types are shared between the processes being represented by nodes 310 and 350. Semantic layer 300 further includes edges 372-376 to indicate other joint object types shared between the corresponding nodes.

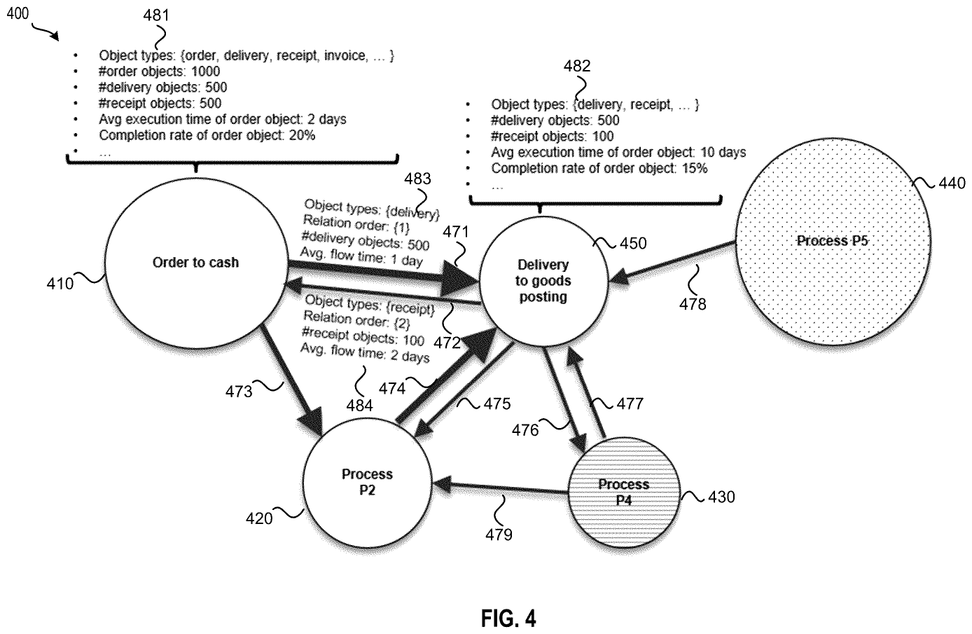

FIG. 4 illustrates an execution layer of a EG model according to some embodiments. As mentioned above, an execution layer of a EG model is generated from data associated with various processes in the system. A EG application may generate the execution layer by expanding the semantic layer with data from real process-level interactions. As shown here, execution layer 400 is generated by applying data to semantic layer 300 of FIG. 3. The data used to generate the execution layer may be a subset of all available data. In other words, the execution layer may present different views based on what data is being presented. An execution layer may be specific to a company. In some embodiments, multiple execution layers may be presented simultaneously on the display to compare and contrast companies. For example, a first execution layer corresponding to one company may be presented on a display and a second execution layer corresponding to another company may be overlaid on top of the first execution layer through highlighting for purposes of visually comparing the two companies. Such presentations of overlaid execution layers are primarily used for benchmarking, allowing companies to compare their EGs with a benchmark EG from a well-performing company to identify potential areas for improvement.

As shown here, execution layer 400 includes nodes 410, 420, 430, 440, and 450. Each node may represent a process of the system. In comparison to semantic layer 300 where each node is the same size, the nodes in execution layer 400 are of different sizes. The EG application may generate different size nodes to represent an attribute of the underlying process being represented by the node. In one embodiment, the size of the node may be directly proportional to the total number of data points in the underlying process. For example, the size of node 410 may be directly proportional to the total number of data points in the underlying process associated with node 410. In another embodiment, the size of the node may be directly proportional to the execution times of the underlying process being represented by the node. The execution time of the underlying process is the average time it takes to run an object instance of the process, from beginning to end. An example of execution time would be after a sales order is created, the average time it takes in the sales order to cash process for all the steps are completed and the money is received. In yet another embodiment, the size of the node may be directly proportional to the completion rates of the underlying process being represented by the node. The completion rate of the underlying process measures the percentage of object instances of a specific object type that terminates successfully (as compared to instances that do not terminate or terminate unsuccessfully. The completion rate may be an average over a given object type or can be a weighted average over a specific object type or all object type. Here, the size of the node is directly proportional to the total data points in the process corresponding to the node. Therefore, node 410 representing a process having a total of 2000 data points (1000 order objects, 500 delivery objects, and 500 receipt objects) is larger in size than node 450 representing a process having a total of 600 data points (delivery objects 500 and receipt objects 100).

Execution layer 400 may optionally display object instance information from the underlying processes. As shown here, execution layer 400 includes text 481 that displays information from the process being represented by node 410. Text 481 displays the object types found in the underlying process, the average execution time of an object, and the average completion rate of an object instance. Similarly, text 483 displays information from process being represented by node 450. The placement of the text may be somewhere in close proximity to the node. Here, text 481 is being displayed above corresponding node 410 and text 482 is being displayed above corresponding node 450. In other embodiments, the information may be displayed to the left, to the right, or below the node. As shown here, not all information is being displayed in text 481 as evidenced by the three dots. Hovering a cursor over text 481 may display the entire list of information. In yet other embodiments, the object types may be displayed as a tool tip which are made visible when a one or more conditions are met. A tool tip is a text box that is displayed when one or more conditions are met. Here, the condition is when a cursor hovers over the node. This may be advantageous particularly in a system where there are many processes and therefore room to display object types for each node is limited.

Execution layer 400 further includes edges 471-479. Each edge corresponds to data related to process interactions between the processes represented by the two nodes connecting the edge. In comparison to semantic graph 300 where all the edges are the same width and bi-directional, the edges in execution layer 400 are of different widths and the direction may vary, where the width depends on the underlying data being represented in the edge and the direction depends on the direction of object instance flow. For example, edge 471 may represent joint object instances of delivery object type that are flowing from a process represented by node 410 to a process represented by node 450 while edge 472 may represent joint object instances of a receipt object type that are flowing from a process represented by node 450 to a process represented by node 410. In other words, there may be more than one edge between two nodes. In one example, each joint object instances of a different object type are represented by its own edge. In another example, joint object instances flowing in one direction are represented as one edge and joint object instances flowing in the other direction are represented by another edge. The direction of flow means that joint object instances are being transmitted as output from one process and being received as input in another process. As shown here, edge 473 is directed from node 410 to node 420, which implies that there are joint object instances in the data set flowing from the process represented by node 410 to the process represented by node 420. However, there is no edge directed from node 420 to node 410, which implies that there are no joint object instances in the data set flowing from the process represented by node 420 to the process represented by node 410.

In some embodiments, the width of an edge may depend on the joint object instances that are being represented by the edge. For example, the width or thickness of an edge may depend on metrics such as the number of joint object instances being represented by the edge or the average flow time of joint object instances through the edge from a source process to a target process. As shown here, edge 471 represents the joint object instances of delivery object type that are flowing from the process represented by node 410 to the process represented by node 450. The thickness or width of edge 471 is directly proportional to the number of joint object instances of delivery object type, which is 500. Similarly, edge 471 represents the joint object instances of receipt object type that are flowing from the process represented by node 450 to the process represented by node 410. The thickness or width of edge 472 is directly proportional to the number of joint object instances of receipt object type, which is 100. Since there is a higher number of joint object instances being represented by edge 471 (e.g., 500 joint object instances) than 472 (e.g., 100 joint object instances), edge 471 is thicker than edge 472. The EG application may generate an execution layer having edges pointing in directions to visually indicate the flow of process interactions between processes and may generate edges having different thicknesses or widths to visually indicate metrics related to those process interactions. These visual indicators provide a simple way for a user to quickly receive insights on the processes in the system and the process interactions between those processes.

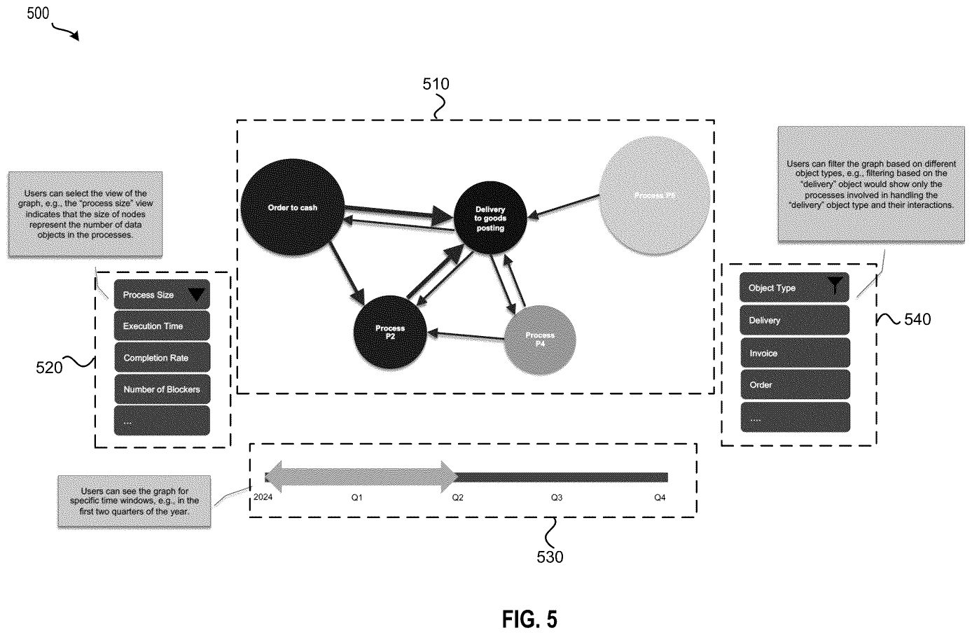

FIG. 5 illustrates a graphical user interface for interacting with an execution layer of EG model according to some embodiments. GUI 500 includes execution layer 510, menu 520, timeline 530, and menu 540. Menu 520 can include a plurality of selectable icons to modify the appearance of the nodes in execution layer 510. The menu can include a process size icon, which when selected, the EG application modifies execution layer 510 such that the size of each node is proportional to the object instances present in the underlying process represented by each node. The method can also include an execution time icon, which when selected, the EG application modifies execution layer 510 such that the size of each node is proportional to the average execution time of object instances present in the underlying process represented by each node. The method can also include a completion rate icon, which when selected, the EG application modifies execution layer 510 such that the size of each node is proportional to the completion rate of object instances present in the underlying process represented by each node. The method can also include a number of blockers icon, which when selected, the EG application modifies execution layer 510 such that the size of each node is proportional to the number of blocked object instances of object instances present in the underlying process represented by each node such as rejected instances, canceled instances, overdue instances, or any other blockers one might want to be informed about.

Timeline 530 can include a selectable slider to define a specific time window to filter out object instances within the processes. As shown here, the first two quarters of 2024 are selected here as indicated by the bidirectional arrow. The user may click and drag the arrows to modify the time window. Once the time window has been set, the EG application can filter the object instances in the processes so that only object instances having a time stamp within the time window are considered when modifying the nodes and the edges in execution layer 510. Menu 530 can include a plurality of selectable icons to modify the appearance of the edges in execution layer 510. The menu can include an object type icon, which when selected, the EG application modifies execution layer 510 such that only edges related to the selected joint object type or types are presented in execution layer 510. As shown here, menu 540 has the following options for filtering by object type-delivery object type, invoice object type, or other object type. If the delivery object type is selected, then edges related to the delivery object type are presented in execution layer 510. If the invoice object type is selected, then edges related to the invoice object type are presented in execution layer 510. More than one object type may be selected.

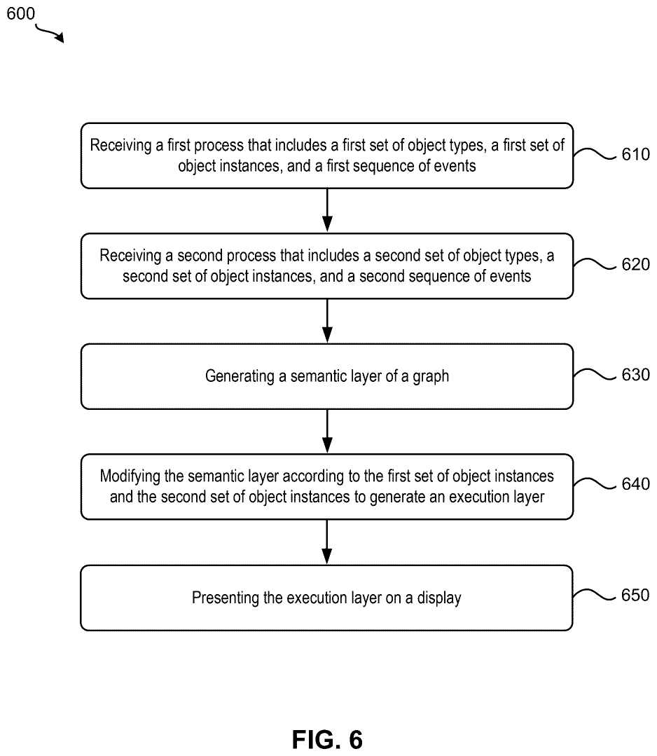

FIG. 6 illustrates a workflow for displaying an execution layer of a EG model according to some embodiments. Workflow 600 may be implemented in computer readable code and executed by a processor. In one embodiment, workflow 600 may be implemented in a EG application. Workflow 600 begins by receiving a first process that includes a first set of object types involved in the first process, a first set of object instances wherein each object instance from the first set of object instances is associated with an object type from the first set of object types, and a first sequence of events detailing the first process, wherein each object instance is assigned to an event from the first sequence of events at step 610. Workflow 600 continues by receiving a second process that includes a second set of object types involved in the second process, a second set of object instances wherein each object instance from the second set of object instances is associated with an object type from the second set of object types, and a second sequence of events detailing the second process, wherein each object instance is assigned to an event from the second sequence of events, and wherein the first set of object types and the second set of object types share an object type at step 620. There may be more than two processes received as the number of processes received dictates the number of nodes in the EG model. Once the processes have been received, workflow 600 continues by generating a semantic layer of a graph at step 630. The graph may be a EG model. Generating the semantic layer can include creating a first node that represents the first process, a second node that represents the second process, and an edge between the first node and the second node that represents the one or more object types shared between the first process and the second process. Once the semantic layer has been generated, workflow 600 continues by modifying the semantic layer according to the first set of object instances and the second set of object instances to generate an execution layer at step 640. Once the execution layer has been generated, workflow 600 continues by presenting the execution layer on a display. In some examples, the execution layer may be presented on a graphical user interface along with menus to modify view of the execution layer.

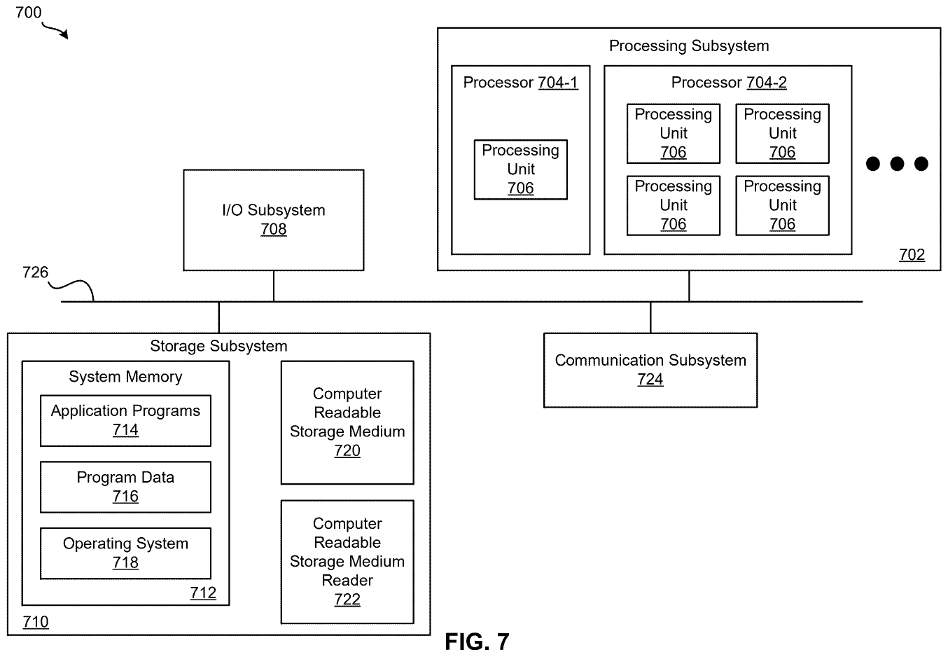

FIG. 7 illustrates an exemplary computer system 700 for implementing various embodiments described above. For example, computer system 700 may be used to execute the EG application. Computer system 700 may be a desktop computer, a laptop, a server computer, or any other type of computer system or combination thereof. Computer system 700 can implement many of the operations, methods, and/or processes described above. As shown in FIG. 7, computer system 700 includes processing subsystem 702, which communicates, via bus subsystem 726, with input/output (I/O) subsystem 708, storage subsystem 710 and communication subsystem 724.

Bus subsystem 726 is configured to facilitate communication among the various components and subsystems of computer system 700. While bus subsystem 726 is illustrated in FIG. 7 as a single bus, one of ordinary skill in the art will understand that bus subsystem 726 may be implemented as multiple buses. Bus subsystem 726 may be any of several types of bus structures (e.g., a memory bus or memory controller, a peripheral bus, a local bus, etc.) using any of a variety of bus architectures. Examples of bus architectures may include an Industry Standard Architecture (ISA) bus, a Micro Channel Architecture (MCA) bus, an Enhanced ISA (EISA) bus, a Video Electronics Standards Association (VESA) local bus, a Peripheral Component Interconnect (PCI) bus, a Universal Serial Bus (USB), etc.

Processing subsystem 702, which can be implemented as one or more integrated circuits (e.g., a conventional microprocessor or microcontroller), controls the operation of computer system 700. Processing subsystem 702 may include one or more processors 704. Each processor 704 may include one processing unit 706 (e.g., a single core processor such as processor 704-1) or several processing units 706 (e.g., a multicore processor such as processor 704-2). In some embodiments, processors 704 of processing subsystem 702 may be implemented as independent processors while, in other embodiments, processors 704 of processing subsystem 702 may be implemented as multiple processors integrate into a single chip or multiple chips. Still, in some embodiments, processors 704 of processing subsystem 702 may be implemented as a combination of independent processors and multiple processors integrated into a single chip or multiple chips.

In some embodiments, processing subsystem 702 can execute a variety of programs or processes in response to program code and can maintain multiple concurrently executing programs or processes. At any given time, some or all of the program code to be executed can reside in processing subsystem 702 and/or in storage subsystem 710. Through suitable programming, processing subsystem 702 can provide various functionalities, such as the functionalities described above by reference to workflows 400, 500 and 600.

I/O subsystem 708 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 700 to a user or another device (e.g., a printer).

As illustrated in FIG. 7, storage subsystem 710 includes system memory 712, computer-readable storage medium 720, and computer-readable storage medium reader 722. System memory 712 may be configured to store software in the form of program instructions that are loadable and executable by processing subsystem 702 as well as data generated during the execution of program instructions. In some embodiments, system memory 712 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 712 may include different types of memory, such as static random access memory (SRAM) and/or dynamic random access memory (DRAM). System memory 712 may include a basic input/output system (BIOS), in some embodiments, that is configured to store basic routines to facilitate transferring information between elements within computer system 700 (e.g., during start-up). Such a BIOS may be stored in ROM (e.g., a ROM chip), flash memory, or any other type of memory that may be configured to store the BIOS.

As shown in FIG. 7, system memory 712 includes application programs 714 (e.g., application 115), program data 716, and operating system (OS) 718. OS 718 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 7, and Palm OS, WebOS operating systems.

Computer-readable storage medium 720 may be a non-transitory computer-readable medium configured to store software (e.g., programs, code modules, data constructs, instructions, etc.). Many of the components and/or workflows described above may be implemented as software that when executed by a processor or processing unit (e.g., a processor or processing unit of processing subsystem 702) performs the operations of such components and/or processes. Storage subsystem 710 may also store data used for, or generated during, the execution of the software.

Storage subsystem 710 may also include computer-readable storage medium reader 722 that is configured to communicate with computer-readable storage medium 720. Together and, optionally, in combination with system memory 712, computer-readable storage medium 720 may comprehensively represent remote, local, fixed, and/or removable storage devices plus storage media for temporarily and/or more permanently containing, storing, transmitting, and retrieving computer-readable information.

Computer-readable storage medium 720 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSD), flash memory card (e.g., secure digital (SD) cards, CompactFlash cards, etc.), USB flash drives, or any other type of computer-readable storage media or device.

Communication subsystem 724 serves as an interface for receiving data from, and transmitting data to, other devices, computer systems, and networks. For example, communication subsystem 724 may allow computer system 700 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 724 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 724 may provide components configured for wired communication (e.g., Ethernet) in addition to or instead of components configured for wireless communication.

One of ordinary skill in the art will realize that the architecture shown in FIG. 7 is only an example architecture of computer system 700, and that computer system 700 may have additional or fewer components than shown, or a different configuration of components. The various components shown in FIG. 7 may be implemented in hardware, software, firmware or any combination thereof, including one or more signal processing and/or application specific integrated circuits.

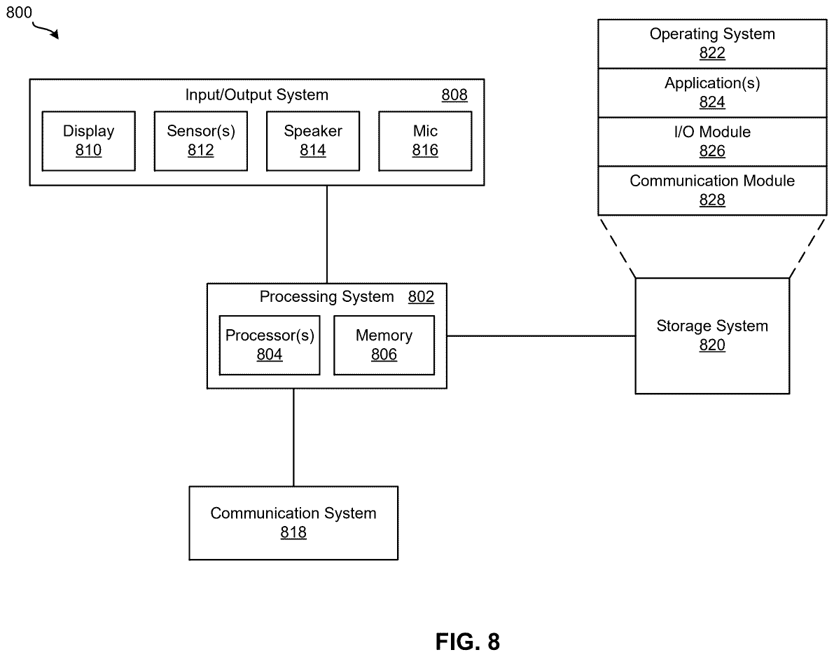

FIG. 8 illustrates an exemplary computing device 800 for implementing various embodiments described above. For example, computing device 800 may be used to execute a EG application. Computing device 800 may be a cellphone, a smartphone, a wearable device, an activity tracker or manager, a tablet, a personal digital assistant (PDA), a media player, or any other type of mobile computing device or combination thereof. As shown in FIG. 8, computing device 800 includes processing system 802, input/output (I/O) system 808, communication system 818, and storage system 820. These components may be coupled by one or more communication buses or signal lines.

Processing system 802, which can be implemented as one or more integrated circuits (e.g., a conventional microprocessor or microcontroller), controls the operation of computing device 800. As shown, processing system 802 includes one or more processors 804 and memory 806. Processors 804 are configured to run or execute various software and/or sets of instructions stored in memory 806 to perform various functions for computing device 800 and to process data.

Each processor of processors 804 may include one processing unit (e.g., a single core processor) or several processing units (e.g., a multicore processor). In some embodiments, processors 804 of processing system 802 may be implemented as independent processors while, in other embodiments, processors 804 of processing system 802 may be implemented as multiple processors integrate into a single chip. Still, in some embodiments, processors 804 of processing system 802 may be implemented as a combination of independent processors and multiple processors integrated into a single chip.

Memory 806 may be configured to receive and store software (e.g., operating system 822, applications 824, I/O module 826, communication module 828, etc. from storage system 820) in the form of program instructions that are loadable and executable by processors 804 as well as data generated during the execution of program instructions. In some embodiments, memory 806 may include volatile memory (e.g., random access memory (RAM)), non-volatile memory (e.g., read-only memory (ROM), programmable read-only memory (PROM), erasable programmable read-only memory (EPROM), electrically erasable programmable read-only memory (EEPROM), flash memory, etc.), or a combination thereof.

I/O system 808 is responsible for receiving input through various components and providing output through various components. As shown for this example, I/O system 808 includes display 810, one or more sensors 812, speaker 814, and microphone 816. Display 810 is configured to output visual information (e.g., a graphical user interface (GUI) generated and/or rendered by processors 804). In some embodiments, display 810 is a touch screen that is configured to also receive touch-based input. Display 810 may be implemented using liquid crystal display (LCD) technology, light-emitting diode (LED) technology, organic LED (OLED) technology, organic electro luminescence (OEL) technology, or any other type of display technologies. Sensors 812 may include any number of different types of sensors for measuring a physical quantity (e.g., temperature, force, pressure, acceleration, orientation, light, radiation, etc.). Speaker 814 is configured to output audio information and microphone 816 is configured to receive audio input. One of ordinary skill in the art will appreciate that I/O system 808 may include any number of additional, fewer, and/or different components. For instance, I/O system 808 may include a keypad or keyboard for receiving input, a port for transmitting data, receiving data and/or power, and/or communicating with another device or component, an image capture component for capturing photos and/or videos, etc.

Communication system 818 serves as an interface for receiving data from, and transmitting data to, other devices, computer systems, and networks. For example, communication system 818 may allow computing device 800 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication system 818 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication system 818 may provide components configured for wired communication (e.g., Ethernet) in addition to or instead of components configured for wireless communication.

Storage system 820 handles the storage and management of data for computing device 800. Storage system 820 may be implemented by one or more non-transitory machine-readable mediums that are configured to store software (e.g., programs, code modules, data constructs, instructions, etc.) and store data used for, or generated during, the execution of the software.

In this example, storage system 820 includes operating system 822, one or more applications 824, I/O module 826, and communication module 828. Operating system 822 includes various procedures, sets of instructions, software components and/or drivers for controlling and managing general system tasks (e.g., memory management, storage device control, power management, etc.) and facilitates communication between various hardware and software components. Operating system 822 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Applications 824 can include any number of different applications installed on computing device 800. Examples of such applications may include a browser application, an address book application, a contact list application, an email application, an instant messaging application, a word processing application, JAVA-enabled applications, an encryption application, a digital rights management application, a voice recognition application, location determination application, a mapping application, a music player application, etc.

I/O module 826 manages information received via input components (e.g., display 810, sensors 812, and microphone 816) and information to be outputted via output components (e.g., display 810 and speaker 814). Communication module 828 facilitates communication with other devices via communication system 818 and includes various software components for handling data received from communication system 818.

One of ordinary skill in the art will realize that the architecture shown in FIG. 8 is only an example architecture of computing device 800, and that computing device 800 may have additional or fewer components than shown, or a different configuration of components. The various components shown in FIG. 8 may be implemented in hardware, software, firmware or any combination thereof, including one or more signal processing and/or application specific integrated circuits.

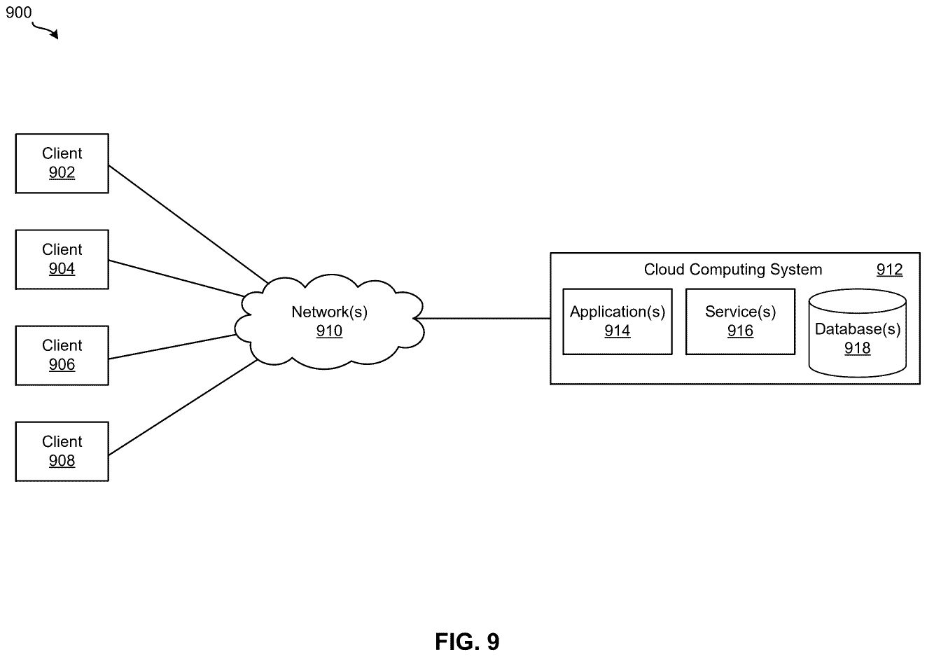

FIG. 9 illustrates an exemplary system 900 for implementing various embodiments described above. For example, cloud computing system 912 may be used to implement the EG application. As shown, system 900 includes client devices 902-908, one or more networks 910, and cloud computing system 912. Cloud computing system 912 is configured to provide resources and data to client devices 902-908 via networks 910. In some embodiments, cloud computing system 900 provides resources to any number of different users (e.g., customers, tenants, organizations, etc.). Cloud computing system 912 may be implemented by one or more computer systems (e.g., servers), virtual machines operating on a computer system, or a combination thereof.

As shown, cloud computing system 912 includes one or more applications 914, one or more services 916, and one or more databases 918. Cloud computing system 900 may provide applications 914, services 916, and databases 918 to any number of different customers in a self-service, subscription-based, elastically scalable, reliable, highly available, and secure manner. One of the applications may be a EG application that is being provided to clients 902-908 as a software as a service.

In some embodiments, cloud computing system 900 may be adapted to automatically provision, manage, and track a customer's subscriptions to services offered by cloud computing system 900. Cloud computing system 900 may provide cloud services via different deployment models. For example, cloud services may be provided under a public cloud model in which cloud computing system 900 is owned by an organization selling cloud services and the cloud services are made available to the general public or different industry enterprises. As another example, cloud services may be provided under a private cloud model in which cloud computing system 900 is operated solely for a single organization and may provide cloud services for one or more entities within the organization. The cloud services may also be provided under a community cloud model in which cloud computing system 900 and the cloud services provided by cloud computing system 900 are shared by several organizations in a related community. The cloud services may also be provided under a hybrid cloud model, which is a combination of two or more of the aforementioned different models.

In some instances, any one of applications 914, services 916, and databases 918 made available to client devices 902-908 via networks 910 from cloud computing system 912 is referred to as a “cloud service.” Typically, servers and systems that make up cloud computing system 912 are different from the on-premises servers and systems of a customer. For example, cloud computing system 912 may host an application and a user of one of client devices 902-908 may order and use the application via networks 910.

Applications 914 may include software applications that are configured to execute on cloud computing system 912 (e.g., a computer system or a virtual machine operating on a computer system) and be accessed, controlled, managed, etc. via client devices 902-908. In some embodiments, applications 914 may include server applications and/or mid-tier applications (e.g., HTTP (hypertext transport protocol) server applications, FTP (file transfer protocol) server applications, CGI (common gateway interface) server applications, JAVA server applications, etc.). Services 916 are software components, modules, application, etc. that are configured to execute on cloud computing system 912 and provide functionalities to client devices 902-908 via networks 910. Services 916 may be web-based services or on-demand cloud services.

Databases 918 are configured to store and/or manage data that is accessed by applications 914, services 916, and/or client devices 902-908. For instance, storages data cache 165, data area 195, redo log buffers 175, redo log segments 180, and redo log backup 185 may be stored in databases 918. Databases 918 may reside on a non-transitory storage medium local to (and/or resident in) cloud computing system 912, in a storage-area network (SAN), on a non-transitory storage medium local located remotely from cloud computing system 912. In some embodiments, databases 918 may include relational databases that are managed by a relational database management system (RDBMS). Databases 918 may be a column-oriented databases, row-oriented databases, or a combination thereof. In some embodiments, some or all of databases 918 are in-memory databases. That is, in some such embodiments, data for databases 918 are stored and managed in memory (e.g., random access memory (RAM)).

Client devices 902-908 are configured to execute and operate a client application (e.g., a web browser, a proprietary client application, etc.) that communicates with applications 914, services 916, and/or databases 918 via networks 910. This way, client devices 902-908 may access the various functionalities provided by applications 914, services 916, and databases 918 while applications 914, services 916, and databases 918 are operating (e.g., hosted) on cloud computing system 900. Client devices 902-908 may be computer system 700 or computing device 800, as described above by reference to FIGS. 7 and 8, respectively. Although system 900 is shown with four client devices, any number of client devices may be supported.

Networks 910 may be any type of network configured to facilitate data communications among client devices 902-1208 and cloud computing system 912 using any of a variety of network protocols. Networks 910 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present disclosure along with examples of how aspects of the present disclosure may be implemented. The above examples and embodiments should not be deemed to be the only embodiments, and are presented to illustrate the flexibility and advantages of various embodiments of the present disclosure as defined by the following claims. Based on the above disclosure and the following claims, other arrangements, embodiments, implementations and equivalents will be evident to those skilled in the art and may be employed without departing from the spirit and scope of the present disclosure as defined by the claims.

1. A non-transitory machine-readable medium storing a program executable by at least one processing unit of a device, the program comprising sets of instructions for:
receiving a first process that includes a first set of object types involved in the first process, a first set of object instances wherein each object instance from the first set of object instances is associated with an object type from the first set of object types, and a first sequence of events detailing the first process, wherein each object instance is assigned to an event from the first sequence of events;
receiving a second process that includes a second set of object types involved in the second process, a second set of object instances wherein each object instance from the second set of object instances is associated with an object type from the second set of object types, and a second sequence of events detailing the second process, wherein each object instance is assigned to an event from the second sequence of events, and wherein the first set of object types and the second set of object types share an object type;
generating a semantic layer of a graph that includes a first node that represents the first process, a second node that represents the second process, and an edge between the first node and the second node that represents the object type shared between the first process and the second process;
modifying an appearance of the semantic layer according to the first set of object instances and the second set of object instances to generate an execution layer; and
presenting the execution layer on a display.

2. The non-transitory machine-readable medium of claim 1, wherein modifying the appearance of the semantic layer includes modifying the size of the first node according to a number of object instances from the first set of object instances that are of an object type from the first set of object types.

3. The non-transitory machine-readable medium of claim 2, wherein the ratio of the size of the first node to the number of instances from the first set of object instances that are of the object type is the same as the ratio of size of the second node to the number of instances from the second set of object instances that are of the object type node.

4. The non-transitory machine-readable medium of claim 1, wherein modifying the appearance of the semantic layer includes modifying the size of the first node according to an average execution time of object instances from the first set of object instances that are of an object type from the first set of object types.

5. The non-transitory machine-readable medium of claim 1, wherein modifying the appearance of the semantic layer includes modifying the size of the first node according to an average completion rate of the first set of object instances that are of an object type from the first set of object types.

6. The non-transitory machine-readable medium of claim 1, wherein modifying the appearance of the semantic layer includes removing the edge when the first set of object instances and the second set of object instances both do not contain at least one object instance having the shared object type.

7. The non-transitory machine-readable medium of claim 1, wherein modifying the appearance of the semantic layer includes adjusting the thickness of the edge based on the number of object instances that are shared between the first set of object instances and the second set of object instances.

8. The non-transitory machine-readable medium of claim 1, wherein modifying the appearance of the semantic layer includes adjusting the direction of the edge based on a flow direction between the first set of object instances and the second set of object instances.

9. The non-transitory machine-readable medium of claim 8, wherein modifying the appearance of the semantic layer adjusting the thickness of the edge based on an average flow time between the first set of object instances and the second set of object instances.

10. A method comprising:
receiving a first process that includes a first set of object types involved in the first process, a first set of object instances wherein each object instance from the first set of object instances is associated with an object type from the first set of object types, and a first sequence of events detailing the first process, wherein each object instance is assigned to an event from the first sequence of events;
receiving a second process that includes a second set of object types involved in the second process, a second set of object instances wherein each object instance from the second set of object instances is associated with an object type from the second set of object types, and a second sequence of events detailing the second process, wherein each object instance is assigned to an event from the second sequence of events, and wherein the first set of object types and the second set of object types share an object type;
generating a semantic layer of a graph that includes a first node that represents the first process, a second node that represents the second process, and an edge between the first node and the second node that represents the object type shared between the first process and the second process;
modifying an appearance of the semantic layer according to the first set of object instances and the second set of object instances to generate an execution layer; and
presenting the execution layer on a display.

11. The method of claim 10, wherein modifying the appearance of the semantic layer includes modifying the size of the first node according to a number of object instances from the first set of object instances that are of an object type from the first set of object types.

12. The method of claim 11, wherein the ratio of the size of the first node to the number of instances from the first set of object instances that are of the object type is the same as the ratio of size of the second node to the number of instances from the second set of object instances that are of the object type node.

13. The method of claim 10, wherein modifying the appearance of the semantic layer includes removing the edge when the first set of object instances and the second set of object instances both do not contain at least one object instance having the shared object type.

14. The method of claim 10, wherein the modifying the appearance of the semantic layer includes adjusting the thickness of the edge based on the number of object instances that are shared between the first set of object instances and the second set of object instances.

15. The method of claim 10, wherein the modifying the appearance of the semantic layer includes adjusting the direction of the edge based on a flow direction between the first set of object instances and the second set of object instances.

16. A system comprising:
a set of processing units; and
a non-transitory machine-readable medium storing instructions that when executed by at least one processing unit in the set of processing units cause the at least one processing unit to:
receive a first process that includes a first set of object types involved in the first process, a first set of object instances wherein each object instance from the first set of object instances is associated with an object type from the first set of object types, and a first sequence of events detailing the first process, wherein each object instance is assigned to an event from the first sequence of events;
receive a second process that includes a second set of object types involved in the second process, a second set of object instances wherein each object instance from the second set of object instances is associated with an object type from the second set of object types, and a second sequence of events detailing the second process, wherein each object instance is assigned to an event from the second sequence of events, and wherein the first set of object types and the second set of object types share an object type;
generate a semantic layer of a graph that includes a first node that represents the first process, a second node that represents the second process, and an edge between the first node and the second node that represents the object type shared between the first process and the second process;
modify the appearance of the semantic layer according to the first set of object instances and the second set of object instances to generate an execution layer; and
present the execution layer on a display.

17. The system of claim 16, wherein modifying the appearance of the semantic layer includes modifying the size of the first node according to a number of object instances from the first set of object instances that are of an object type from the first set of object types.

18. The system of claim 17, wherein the ratio of the size of the first node to the number of instances from the first set of object instances that are of the object type is the same as the ratio of size of the second node to the number of instances from the second set of object instances that are of the object type node.

19. The system of claim 16, wherein modifying the appearance of the semantic layer includes removing the edge when the first set of object instances and the second set of object instances both do not contain at least one object instance having the shared object type.

20. The system of claim 16, wherein the modifying the appearance of the semantic layer includes adjusting the thickness of the edge based on the number of object instances that are shared between the first set of object instances and the second set of object instances.
